(19) United States
(12) Patent Application Publication
(10) Pub. No.: US 2025/0071577 A1
(43) Pub. Date: Feb. 27, 2025

(54) DYNAMIC MULTI-CLUSTER MANAGEMENT

(71) Applicant: Nokia Technologies Oy, Espoo (FI)

(72) Inventors: Parisa FOROUGHI, Massy (FR); Hajer BRAHAM, Massy (FR); Abdelrahman ABDELKADER, Munich (DE)

(21) Appl. No.: 18/796,534

(22) Filed: Aug. 7, 2024

Related U.S. Application Data
(60) Provisional application No. 63/533,866, filed on Aug. 21, 2023.

(51) Int. Cl. H04W 24/02; H04W 24/08

(52) U.S. Cl. CPC H04W 24/02; H04W 24/08

(57) ABSTRACT

A method may include transmitting, to a management service producer, a first request to create a set of clusters and to train a machine learning model for one or more clusters in the set of clusters for a plurality of contexts. The method may also include transmitting, to the management service producer, a second request to dynamically monitor the set of clusters. The method may further include receiving, after at least one of the first request or the second request, cluster reports from the management service producer as a result of creation of the set of clusters. The method may also include receiving, after at least one of the first request or the second request, training reports from the management service producer as a result of dynamic monitoring of the set of clusters, and training of the machine learning model.

### FIELD

Some example embodiments may generally relate to mobile or wireless telecommunication systems, such as Long Term Evolution (LTE) or fifth generation (5G) new radio (NR) access technology, or 5G beyond, or other communications systems. For example, certain example embodiments may relate to apparatuses, systems, and/or methods for dynamic multi-cluster management.

### BACKGROUND

Examples of mobile or wireless telecommunication systems may include the Universal Mobile Telecommunications System (UMTS) Terrestrial Radio Access Network (UTRAN), LTE Evolved UTRAN (E-UTRAN), LTE-Advanced (LTE-A), MulteFire, LTE-A Pro, fifth generation (5G) radio access technology or NR access technology, and/or 5G-Advanced. 5G wireless systems refer to the next generation (NG) of radio systems and network architecture. 5G network technology is mostly based on NR technology, but the 5G (or NG) network can also build on E-UTRAN radio. It is estimated that NR may provide bitrates on the order of 10-20 Gbit/s or higher, and may support at least enhanced mobile broadband (eMBB) and ultra-reliable low-latency communication (URLLC) as well as massive machine-type communication (mMTC). NR is expected to deliver extreme broadband and ultra-robust, low-latency connectivity and massive networking to support the IoT.

### SUMMARY

Some example embodiments may be directed to a method. The method may include transmitting, to a management service producer, a first request to create a set of clusters and to train a machine learning model for one or more clusters in the set of clusters for a plurality of contexts. According to certain example embodiments, each cluster may include a plurality of network nodes, network functions, and management functions. The method may also include transmitting, to the management service producer, a second request to dynamically monitor the set of clusters. The method may further include, receiving, after at least one of the first request or the second request, cluster reports from the management service producer as a result of creation of the set of clusters. In addition, the method may include receiving, after at least one of the first request or the second request, training reports from the management service producer as a result of dynamic monitoring of the set of clusters, and training of the machine learning model.

Other example embodiments may be directed to an apparatus. The apparatus may include at least one processor and at least one memory including computer program code. The at least one memory and the computer program code may be configured to, with the at least one processor, cause the apparatus at least to transmit, to a management service producer, a first request to create a set of clusters and to train a machine learning model for one or more clusters in the set of clusters for a plurality of contexts. According to certain example embodiments, each cluster may include a plurality of network nodes, network functions, and management functions. The apparatus may also be caused to transmit, to the management service producer, a second request to dynamically monitor the set of clusters. The apparatus may further be caused to receive, after at least one of the first request or the second request, cluster reports from the management service producer as a result of creation of the set of clusters. In addition, the apparatus may be caused to receive, after at least one of the first request or the second request, training reports from the management service producer as a result of dynamic monitoring of the set of clusters, and training of the machine learning model.

Other example embodiments may be directed to an apparatus. The apparatus may include means for transmitting, to a management service producer, a first request to create a set of clusters and to train a machine learning model for one or more clusters in the set of clusters for a plurality of contexts. According to certain example embodiments, each cluster may include a plurality of network nodes, network functions, and management functions. The apparatus may also include means for transmitting, to the management service producer, a second request to dynamically monitor the set of clusters. The apparatus may further include means for receiving, after at least one of the first request or the second request, cluster reports from the management service producer as a result of creation of the set of clusters. In addition, the apparatus may include means for receiving, after at least one of the first request or the second request, training reports from the management service producer as a result of dynamic monitoring of the set of clusters, and training of the machine learning model.

In accordance with other example embodiments, a non-transitory computer readable medium may be encoded with instructions that may, when executed in hardware, perform a method. The method may include transmitting, to a management service producer, a first request to create a set of clusters and to train a machine learning model for one or more clusters in the set of clusters for a plurality of contexts. According to certain example embodiments, each cluster may include a plurality of network nodes, network functions, and management functions. The method may also include transmitting, to the management service producer, a second request to dynamically monitor the set of clusters. The method may further include, receiving, after at least one of the first request or the second request, cluster reports from the management service producer as a result of creation of the set of clusters. In addition, the method may include receiving, after at least one of the first request or the second request, training reports from the management service producer as a result of dynamic monitoring of the set of clusters, and training of the machine learning model.

Other example embodiments may be directed to a computer program product that performs a method. The method may include transmitting, to a management service producer, a first request to create a set of clusters and to train a machine learning model for one or more clusters in the set of clusters for a plurality of contexts. According to certain example embodiments, each cluster may include a plurality of network nodes, network functions, and management functions. The method may also include transmitting, to the management service producer, a second request to dynamically monitor the set of clusters. The method may further include, receiving, after at least one of the first request or the second request, cluster reports from the management service producer as a result of creation of the set of clusters. In addition, the method may include receiving, after at least one of the first request or the second request, training reports from the management service producer as a result of dynamic monitoring of the set of clusters, and training of the machine learning model.

Other example embodiments may be directed to an apparatus that may include circuitry configured to transmit, to a management service producer, a first request to create a set of clusters and to train a machine learning model for one or more clusters in the set of clusters for a plurality of contexts. According to certain example embodiments, each cluster may include a plurality of network nodes, network functions, and management functions. The apparatus may also include circuitry configured to transmit, to the management service producer, a second request to dynamically monitor the set of clusters. The apparatus may further include circuitry configured to receive, after at least one of the first request or the second request, cluster reports from the management service producer as a result of creation of the set of clusters. In addition, the apparatus may include circuitry configured to receive, after at least one of the first request or the second request, training reports from the management service producer as a result of dynamic monitoring of the set of clusters, and training of the machine learning model.

Further example embodiments may be directed to a method. The method may include receiving, from a management service consumer, a first request to create a set of clusters and to train a machine learning model for one or more clusters in the set of clusters for a plurality of different contexts. According to certain example embodiments, each cluster may include a plurality of network nodes, network functions, and management functions. The method may also include receiving, from the management service consumer, a second request to dynamically monitor the set of clusters. The method may further include creating, based on the first request, the set of clusters. According to certain example embodiments, each cluster of the set of clusters may be associated with the machine learning model. In addition, the method may include training, based on the first request, the machine learning model for the one or more clusters in the set of clusters for the plurality of different contexts. Further, the method may include performing, based on the second request, a dynamic monitoring procedure to monitor the clusters in the set of clusters. The method may also include transmitting cluster reports to the management service consumer based on the creating the set of clusters. The method may further include transmitting training reports to the management service consumer based on performing the dynamic monitoring of the set of clusters, and the training of the machine learning model.

Other example embodiments may be directed to an apparatus. The apparatus may include at least one processor and at least one memory including computer program code. The at least one memory and the computer program code may be configured to, with the at least one processor, cause the apparatus at least to receive, from a management service consumer, a first request to create a set of clusters and to train a machine learning model for one or more clusters in the set of clusters for a plurality of different contexts. According to certain example embodiments, each cluster may include a plurality of network nodes, network functions, and management functions. The apparatus may also be caused to receive, from the management service consumer, a second request to dynamically monitor the set of clusters. The apparatus may further be caused to create, based on the first request, the set of clusters. According to certain example embodiments, each cluster of the set of clusters may be associated with the machine learning model. In addition, the apparatus may be caused to train, based on the first request, the machine learning model for the one or more clusters in the set of clusters for the plurality of different contexts. Further, the apparatus may be caused to perform, based on the second request, a dynamic monitoring procedure to monitor the clusters in the set of clusters. The apparatus may also be caused to transmit cluster reports to the management service consumer based on the creating the set of clusters. The apparatus may further be caused to transmit training reports to the management service consumer based on performing the dynamic monitoring of the set of clusters, and the training of the machine learning model.

Other example embodiments may be directed to an apparatus. The apparatus may include means for receiving, from a management service consumer, a first request to create a set of clusters and to train a machine learning model for one or more clusters in the set of clusters for a plurality of different contexts. According to certain example embodiments, each cluster may include a plurality of network nodes, network functions, and management functions. The apparatus may also include means for receive, from the management service consumer, a second request to dynamically monitor the set of clusters. The apparatus may further include means for creating, based on the first request, the set of clusters. According to certain example embodiments, each cluster of the set of clusters may be associated with the machine learning model. In addition, the apparatus may include means for training, based on the first request, the machine learning model for the one or more clusters in the set of clusters for the plurality of different contexts. Further, the apparatus may include means for performing, based on the second request, a dynamic monitoring procedure to monitor the clusters in the set of clusters. The apparatus may also include means for transmitting cluster reports to the management service consumer based on the creating the set of clusters. The apparatus may further include means for transmitting training reports to the management service consumer based on performing the dynamic monitoring of the set of clusters, and the training of the machine learning model.

In accordance with other example embodiments, a non-transitory computer readable medium may be encoded with instructions that may, when executed in hardware, perform a method. The method may include receiving, from a management service consumer, a first request to create a set of clusters and to train a machine learning model for one or more clusters in the set of clusters for a plurality of different contexts. According to certain example embodiments, each cluster may include a plurality of network nodes, network functions, and management functions. The method may also include receiving, from the management service consumer, a second request to dynamically monitor the set of clusters. The method may further include creating, based on the first request, the set of clusters. According to certain example embodiments, each cluster of the set of clusters may be associated with the machine learning model. In addition, the method may include training, based on the first request, the machine learning model for the one or more clusters in the set of clusters for the plurality of different contexts. Further, the method may include performing, based on the second request, a dynamic monitoring procedure to monitor the clusters in the set of clusters. The method may also include transmitting cluster reports to the management service consumer based on the creating the set of clusters. The method may further include transmitting training reports to the management service consumer based on performing the dynamic monitoring of the set of clusters, and the training of the machine learning model.

Other example embodiments may be directed to a computer program product that performs a method. The method may include receiving, from a management service consumer, a first request to create a set of clusters and to train a machine learning model for one or more clusters in the set of clusters for a plurality of different contexts. According to certain example embodiments, each cluster may include a plurality of network nodes, network functions, and management functions. The method may also include receiving, from the management service consumer, a second request to dynamically monitor the set of clusters. The method may further include creating, based on the first request, the set of clusters. According to certain example embodiments, each cluster of the set of clusters may be associated with the machine learning model. In addition, the method may include training, based on the first request, the machine learning model for the one or more clusters in the set of clusters for the plurality of different contexts. Further, the method may include performing, based on the second request, a dynamic monitoring procedure to monitor the clusters in the set of clusters. The method may also include transmitting cluster reports to the management service consumer based on the creating the set of clusters. The method may further include transmitting training reports to the management service consumer based on performing the dynamic monitoring of the set of clusters, and the training of the machine learning model.

Other example embodiments may be directed to an apparatus that may include circuitry configured to receive, from a management service consumer, a first request to create a set of clusters and to train a machine learning model for one or more clusters in the set of clusters for a plurality of different contexts. According to certain example embodiments, each cluster may include a plurality of network nodes, network functions, and management functions. The apparatus may also include circuitry configured to receive, from the management service consumer, a second request to dynamically monitor the set of clusters. The apparatus may further include circuitry configured to create, based on the first request, the set of clusters. According to certain example embodiments, each cluster of the set of clusters may be associated with the machine learning model. In addition, the apparatus may include circuitry configured to train, based on the first request, the machine learning model for the one or more clusters in the set of clusters for the plurality of different contexts. Further, the apparatus may include circuitry configured to perform, based on the second request, a dynamic monitoring procedure to monitor the clusters in the set of clusters. The apparatus may also include circuitry configured to transmit cluster reports to the management service consumer based on the creating the set of clusters. The apparatus may further include circuitry configured to transmit training reports to the management service consumer based on performing the dynamic monitoring of the set of clusters, and the training of the machine learning model.

### BRIEF DESCRIPTION OF THE DRAWINGS

For proper understanding of example embodiments, reference should be made to the accompanying drawings, wherein:

FIG. 1 illustrates an example signal diagram of a cluster creation request, according to certain example embodiments.

FIG. 2 illustrates an example signal diagram of another cluster creation request, according to certain example embodiments.

FIG. 3 illustrates an example signal diagram of a dynamic cluster monitoring request, according to certain example embodiments.

FIG. 4 illustrates an example signal diagram of a procedure for a machine learning training request, according to certain example embodiments.

FIG. 5 illustrates a class unified modeling language diagram, according to certain example embodiments.

FIG. 6 illustrates another class unified modeling language diagram, according to certain example embodiments.

FIG. 7 illustrates an example flow diagram of a method, according to certain example embodiments.

FIG. 8 illustrates an example flow diagram of another method, according to certain example embodiments.

FIG. 9 illustrates a set of apparatuses, according to certain example embodiments.

### DETAILED DESCRIPTION

It will be readily understood that the components of certain example embodiments, as generally described and illustrated in the figures herein, may be arranged and designed in a wide variety of different configurations. The following is a detailed description of some example embodiments of systems, methods, apparatuses, and computer program products for dynamic multi-cluster management. In certain example embodiments, the dynamic multi-cluster management may involve management for artificial intelligence/machine learning (AIML) training.

The features, structures, or characteristics of example embodiments described throughout this specification may be combined in any suitable manner in one or more example embodiments. For example, the usage of the phrases “certain embodiments,” “an example embodiment,” “some embodiments,” or other similar language, throughout this specification refers to the fact that a particular feature, structure, or characteristic described in connection with an embodiment may be included in at least one embodiment. Thus, appearances of the phrases “in certain embodiments,” “an example embodiment,” “in some embodiments,” “in other embodiments,” or other similar language, throughout this specification do not necessarily refer to the same group of embodiments, and the described features, structures, or characteristics may be combined in any suitable manner in one or more example embodiments. Further, the terms “base station”, “cell”, “node”, “gNB”, “network” or other similar language throughout this specification may be used interchangeably.

As used herein, “at least one of the following: <a list of two or more elements>” and “at least one of <a list of two or more elements>” and similar wording, where the list of two or more elements are joined by “and” or “or,” mean at least any one of the elements, or at least any two or more of the elements, or at least all the elements.

According to the specifications of the 3^{rd} Generation Partnership Project (3GPP), communication networks may be built from instances of the same functions and entities that are deployed at different locations and in different situations to achieve a common goal. However, if these functions and entities were to be equipped with artificial intelligence (AI) (i.e., AI model), each entity or function may need different training data due to the difference in their deployment context and environment. 3GPP describes a way to enable this training through attributes such as MLContext (i.e., AIMLContext). The AIMLContext may represent the status and conditions related to an AIMLEntity. Specifically, it may be one of three types of context including, for example, an ExpectedRunTimeContext, a TrainingContext, and a RunTimeContext. However, the maintenance and retraining of these models over time is not available. It may be assumed to be based on ad-hoc requests by either the instances or by an operator. 3GPP provides the means for requesting training processes and managing (i.e., start, suspend, and restart) these processes. There are also some reports on the training process. However, the current ad-hoc and tunnel-view on the training is not sufficient for training AIML models in scale.

There is currently no monitoring and maintenance approach for updating one or several MLEntities (i.e., AIML entity). The AIMLEntity may be either an AIML model or AIML-enabled function. AIMLTraining may be requested for either an AIML model or an AIML-enabled function. For each AIMLEntity under training, one or more AIMLTrainingProcess may be instantiated. The EIMLEntity may include 3 types of contexts—TrainingContext which is the context under which the AIMLEntity has been trained, the ExpectedRunTimeContext which is the context where the AIMLEntity is expected to be applied, or the RunTimeContext which is the context where the model is being applied.

Currently, there is no monitoring and maintenance approach for updating one or several MLEntities. Despite the diversity of situations and contexts in which an AIML entity may be operating in, it may be reasonable to assume that there may be similarities in what a certain entity undergoes. Thus, there may be a chance of determining groups of entities or functions performing the same functionality at different locations where they are similar enough in terms of their operational state to share one trained model for their specific use case.

Before an AIML model can be deployed in the operational environment to conduct inference or predictions, the AIML model needs to be properly trained. Conventional approaches to training these models may include deployment of one single trained model to each entity/node, and then performance of a round of retraining to customize the model for that particular entity/node and context. However, this approach suffers from various challenges including, for example, scalability related challenges and analytical related challenges. The scalability related challenges may include that training a model per entity/node calls for a significant amount of computation and, thus, is not energy efficient. Additionally, a greater number of ML entities increases the complexity of maintenance of each model's performance. Management of the models is also far from efficient and ideal. As to the analytical challenges, despite the additional complexity in maintenance, there is no gained knowledge and insight on the network performance, changes, and the environment's impact on the network entities in a statistical manner.

In view of the various challenges, one hindering factor in the application and integration of the AIML capabilities in 3GPP networks is the management and maintenance of the models. This problem elevates in importance and severity where the network is required to use AI at larger scales.

In view of the challenges and drawbacks described above, certain example embodiments may provide an approach to dynamically manage and monitor the training of AIML models for a network, e.g., a 3GPP network. In doing so, certain example embodiments may provide usage of the clustering concept and introduce management operations (i.e., BreakNMerge, expand, classify, and reset) to maintain the trained clusters by some form of re-clustering. The capabilities of such service may include an authorized clustering management service (MnS) consumer transmitting a request for clustering of a group of nodes (i.e., functions including AIML models, entities, etc.) with distinct data network (DN)/identifiers or identifications (IDs) for a given MLEntityId, and a set of information indicating the clustering criteria. This step may or may not include various stages of whether or not a service producer (e.g., MnS producer) is requesting to instantiate the training. If the MnS producer is to instantiate the training requests, it may perform clustering operations and determine the node-to-cluster associations. The MnS producer may also generate the MLEntities with corresponding MLContext as well as the version assignment. The MnS producer may also place the request for training the MLEntities created. After the training process is completed, the MnS producer may decommission the already operational MLEntities that were previously provided for the same nodes.

According to certain example embodiments, the service producer (e.g., MnS producer) may provide a report of the clusters, node associations, and description/details of the clustering criteria. According to other example embodiments, an authorized consumer may request for the monitoring of a set of clusters (e.g., a set of MLEntities with a similar ID and different versions) to be maintained and managed by performing one or several clustering operations (e.g., expand, break, merge, classify, and reset) given a set of conditions based on a self-organized fashion by providing generic re-clustering conditions, an event-triggered manner by providing event handles, and/or a hybrid sense by considering both conditions. According to certain example embodiments, in this step, the service producer may be responsible for triggering a training process without a need for a training request from the consumers.

In certain example embodiments, the training processes may be triggered based on the clustering operations' conditions provided by the consumer or based on default values. Alternatively, a monitoring process may be triggered based on enabling the cluster monitoring capability on ad-hoc MLEntities. In this example, the service producer may additionally group the MLEntities based on their IDs and take care of this monitoring for each unique ID. This latter approach allows for integration of new versions of MLEntities to be inserted to the clustering process, and removes versions that are no longer necessary in the clusters. In other example embodiments, the clustering MnS producer may provide reports to the authorized consumer on any rearrangements or triggering of any clustering operations, and provide statistics and descriptions for the triggers of the recalculation.

According to certain example embodiments, the MnS may correspond to a set of offered capabilities for management and orchestration of the network and services. The entity producing an MnS is called an MnS producer, and the entity consuming an MnS is called an MnS consumer. An MnS provided by an MnS producer may be consumed by any entity with appropriate authorization and authentication. In some example embodiments, the MnS producer may offer its services via a standardized service interface composed of individually specified MnS components.

In certain example embodiments, a dynamic multi-cluster management mechanism may enable cluster training and management of these clusters. Cluster training may refer to a procedure in which when a given AIML entity (identified by its input, output, and ML model such as, for example, the MLEntityId) may be expected to be trained for a group of nodes/entities (e.g., functions, terminals, etc.), for different contexts and/or for different inference locations based on their operation needs. In other words, in a cluster, it may be possible to perform training and hand-substitute multiple training requests corresponding to different MLexpectedRuntimeContexts for a given MLmodelMLentity that are meant to be utilized on different interface entities.

According to certain example embodiments, a cluster training criteria may determine the proper association of the nodes/instances (inference nodes) to clusters that are formed based on the conditions and requirements in the clustering criteria. The clustering may be based on, for example, multi-variate clustering methods, or a univariate method. The multi-variate clustering methods may use either the input data of the MLEntity or alternatively, use a set of provided features that are known to have a considerable impact on the model's performance. In the univariate method, the method may be based on one distinctive feature either from the model input or the features provided in the request as domain and model design knowledge.

In certain example embodiments, a clustering approach may provide several clusters where each cluster may have one trained model with tuned hyperparameters. In each cluster, the same trained model corresponding to its cluster may be duplicated and instantiated on the nodes forming the cluster. Certain example embodiments may define certain attributes to be able to impact the creation and the dynamic monitoring of the clusters.

The service associated with cluster dynamic manage for model training may be introduced as an extension to the training requests, or may be modeled and provisioned as a separate cluster monitoring request. However, certain example embodiments provide a way to perform cluster dynamic monitoring in which a node (e.g., model instance or ML entity) that was not previously part of a cluster, hereafter referred to as an external node, can enter the dynamic clustering and maintenance. The cluster dynamic monitoring may also provide for a node (e.g., model instance or ML entity) inside the clusters, hereinafter referred to as internal node, to exit this clustering service upon a change in the training request attribute.

According to certain example embodiments, to enable clustering of the MLEntities with similar IDs (i.e., similar IDs can be defined as having at least one of the following: the same input, the same output, or the same architecture) as a service, the proper information should be provide. For instance, certain example embodiments may provide a set of attributes that provide the means for requesting a dynamic clustering request (see Table 1). The attributes may be provided for placing a clustering request, and may include: MLEntityId; ClusteringCriteriaFeatures; ClusteringCriteriaOnly; MinClusterSize; MinExpectedAccuracy; AcceptedAccuracyMargin; MaxNodeOutlierPercentage; and MethodologyId.

The MLEntityId may represent the information regarding the input features, the output format, and the ML algorithm category (convolutional neural network (CNN), artificial neural network (ANN), virtual spatial models (VSM), etc.), as well as a version of a model, or the MLEntity identified by the ID has associated with it all these items. In some example embodiments, this attribute may be mandatory. The ClusteringCriteriaFeatures may be a way of introducing one or more features to be used for the clustering, and this attribute may be optional. ClusteringCriteriaOnly may be a Boolean attribute that is used to indicate to the clustering approach. It may be used to indicate to only cluster based on the provided features in the ClusteringCriteriaFeatures. If the ClusteringCriteriaOnly attribute is not assigned, the input features of the model will be used as input for clustering criteria. Accordingly, this feature may impact the source of data in the clustering methodology, and the default value may be false.

The MinClusterSize may represent the minimum number of nodes that can form a cluster. The nodes that do not fit in any of the clusters with appropriate accuracy may be excluded. MinExpectedAccuracy may represent the minimum allowed accuracy value for the clusters. Additionally, the AcceptedAccuracyMargin may represent the margin allowing for flexibility in the achievement of accuracy on different clusters, and this may be an optional attribute. MaxNodeOutlierPercentage may corresponds to the maximum percentage of nodes that are allowed to be outliers during the clustering process. These nodes may be excluded from the cluster training if they violate the minimum expected accuracy of the clusters, or are not similar enough based on the clustering criteria. These nodes may be allocated a dedicated model that may be trained on their own data and may be tailored to their special circumstances. MethodologyId may represent the ID of the clustering method. This information may be exposed by the clustering MnS producer upon acquiring about the supported clustering methodologies. expectedRuntimeContextSet may be a set of expectedRuntimeContexts for which the referenced MLEntity would be trained.

TABLE 1
Attributes for placing a clustering request

| | | Information Type/ | |
|---|---|---|---|
| Parameter Name | S | Legal Values | Description |
| clusterTrainingRequestId | M | String | It indicates ID of the request for |
| | | | clustering |
| mlEntityId | M | String | It indicates the ID of the MLEntity of |
| | | | concerns for the clustering |
| clusteringCriteriaFeatures | O | DN | It is an alternative or complementary |
| | | | way of introducing one or more features |
| | | | to be used for the clustering |
| clusteringCriteriaOnly | M | Boolean | It indicates to only cluster based on the |
| | | | provided features in the |
| | | | ClusteringCriteriaFeatures. If it is not |
| | | | assigned the input features of the model |
| | | | will be used as the input for clustering |
| | | | criteria. |
| | | | allowedValues: TRUE, FALSE |
| minClusterSize | O | Integer | It indicates the minimum number of |
| | | | nodes in a cluster |
| minsExpectedAccuracy | M | ModelPerformance | The minimum allowed accuracy value |
| | | | for the clusters (in unit of percentage) |
| acceptedAccuracyMargin | O | ModelPerformance | The margin allowing for flexibility in |
| | | | the achievement of accuracy on different |
| | | | clusters |
| maxNodeOutlierPercentage | O | Integer | It indicates the percentage of maximum |
| | | | nodes that are allowed to be outliers to |
| | | | the clustering process. allowed Values: |
| | | | { 0 . . . 100 } |
| methodologyID | M | String | It indicates the clustering method ID |
| expectedRuntimeContextSet | O | List | It indicates a list of |
| | | | expectedRuntimeContexts for which the |
| | | | referenced MLentity would be trained |

In other example embodiments, as an alternative to the clustering request, the clustering approach may be supported by providing a new attribute in the training request, called EnableClustering. The MLEntities with the same IDs and the enabled EnableClustering may be considered as different clusters, and may be grouped and re-clustered appropriately based on default values. For dynamic monitoring of the clusters created in this manner, a request may be placed.

According to certain example embodiments, after a set of clusters are created, they may be monitored to maintain the quality of inference and performance of the model in the network. To provide the necessary control handles to the consumer, certain attributes may be provided in a cluster dynamic monitoring request to perform cluster dynamic monitoring of the set of clusters (see Table 2). The attributes may include ClusterDynMonitoringRequestId, MLEntityId, MLEntityVersions, ClusterIds, ClusteringOperationConditions, and ReportTimeWindow. The ClusterDynMonitoringRequestID may represent the ID of the request for dynamic monitoring of set of clusters. The MLEntityID may represent the MLEntityId that points to a parent ML model with a particular input, output, and architecture. In other words, it is pointing to the parent ML model.

The MLEntityVersions may corresponds to a list of versions of the parent model that has been generated as a result of the clustering request, or a list of versions of the parent model that has been grouped as a result of them expressing their willingness to be part of this clustering. ClusterIds may correspond to the list of clusterIds for which the dynamic monitoring request is handling operations. The ClusteringOperationConditions may refer to a list of operation objects/OperationIds that provide the information necessary for managing and controlling each operation. Additionally, the ReportTimeWindow is at time window that is considered for calculation of the statistical information in the reports and operations when no time frame is specified. It may also be expressed in terms of number of inferences or number of operations.

TABLE 2
Attributes for a cluster dynamic monitoring request

| | | Information Type/ | |
|---|---|---|---|
| Parameter Name | S | Legal Values | Description |
| ClusterMonitoringRequestId | M | String | It indicates the id of the request for |
| | | | dynamic monitoring of a set of clusters. |
| MLEntityld | M | String | It indicates the ID of the MLEntity of |
| | | | concerns for the clustering |
| MLEntityVersions | M | String | It indicates the version number of the |
| | | | ML entity. |
| ClusterIds | O | Array[String] | It is the list of IDs the dynamic |
| | | | monitoring request is handling the |
| | | | operations for |
| ClusteringOperationConditons | M | Operation | It indicates the operation characteristics |
| | | | that provide the information necessary |
| | | | for managing and controlling each |
| | | | operation. |
| ReportTimeWindow | M | TimeWindow | The time window that is considered for |
| | | | calculation of the statistical information |
| | | | in the reports and operations when no |
| | | | time frame is specified. It can be also |
| | | | expressed in terms of number of |
| | | | inferences or number of operations. |

According to certain example embodiments, management operations may be used for dynamic management of the created clusters. The management of these clusters may be performed to keep the performance of the models in an acceptable zone based on the clustering criteria and conditions. The management and control may provide the opportunity of sharing a trained model with several nodes while keeping up with their performance requirements. Moreover, due to generalization of one model for several nodes instead of customization per node, a higher level of management may be needed to maintain the performance of the nodes. To accommodate the nuances stemming from the clustering and the resulted level of generalization, certain example embodiments may provide operations including but not limited to, for example, classification, expanding, breaking, BreakNMerge, and resetting.

In the classifying operation, a node can change its cluster if the conditions for this operation are met. In this operation, the MLEntity version (i.e., the model details) in each cluster may not change and, thus, there is no need for retraining. This operation may change the nodes inside cluster, which means that the same model may be associated to different nodes. The expand operation may refer to a scenario where a cluster may need to be expanded by further training on new observations to accommodate a higher accuracy in later inferences, or keep up with the required accuracy of the nodes. The cluster may also be trained on observations from another set of nodes to accommodate more nodes in one cluster (merge). The breaking operation may refer to a cluster that can be broken down to two or more clusters if certain conditions for this operation are satisfied. In this case, the clustering may be needed to perform retraining or changing hyper parameters for the new clusters such that the clustering criteria are satisfied. Based on the number of resulted clusters from this break operation, there may be a need for additional trainings (e.g., 1 or more).

The BreakNMerge operation may refer to a situation where the clusters can be first broken down to smaller clusters appropriately based on the conditions, and then merged accordingly to form a better and more consistent and efficient set of clusters. This operation may be triggered to enable fewer alternations in classifications (i.e., triggering of Classify operation among two clusters) and, thus, improving both the management and the merged cluster accuracy. In the reset operation, a complete re-clustering may be performed, and this may be similar in process to the original creation of the clusters.

According to certain example embodiments, each operation may have certain attributes to enable the management of the clusters on the operation level, and provide a level of flexibility in the reports. For instance, management of the clusters may be based on potential conditions that can be assumed on the attributes of the operations. As one example embodiment, if a maxClusterStabilitylevel of an operation (e.g., break) is set to 70% then, if any of the clusters has less than this value, the break operation will separate the cluster such that the stability level of the new clusters is more than this value. To create these new clusters, it may be possible to use the guest nodes and minimum accepted accuracy of the clusters in mind. It may also be possible to regroup the nodes such that the conditions of the clusters will meet the requirements and none of the other operations are triggered. The triggering of the operations may often is when one or more of the operation's attributes are violated when it is time to check them. How often the operation's attributes are checked may be based on the conditionFullfillmentCheckRate attribute. Additionally, the attributes may provide explanations for how the cluster management makes decisions and manage the training of its managed nodes (see Table 3). As shown in Table 3, the operational attributes may include an OperationId, type, EventType, MinAccuracy, ConditionFullfillmentCheckRate, MaxClusterStability level, and OutliersCount.

TABLE 3
Operation attributes

| | | Information Type/ | |
|---|---|---|---|
| Parameter Name | S | Legal Values | Description |
| operationId | M | String | It indicates the id that points to a |
| | | | particular operation running under a |
| | | | particular cluster monitoring request |
| type | M | Enum | it indicates the type of operation |
| | | | AllowedValue: {CLASSIFY, EXPAND. |
| | | | BREAK, MERGE, RESET} |
| eventType | O | String | the type of a defined event or output in |
| | | | analytics that can be the trigger for the |
| | | | operation in question. This attribute is |
| | | | optional. |
| | | | AllowedValues: the value of MDA type |
| | | | defined for each MDA capability in |
| | | | clause 8, 28.104 |
| minAccuracy | M | ModelPerformance | The minimum acceptable accuracy for |
| | | | this operation to be triggered and result |
| | | | in a change in the clusters. |
| conditionFullfillmentCheckRate | M | TimeWindow | It indicates how often the operation |
| | | | conditions shall be checked. This |
| | | | attribute is expressed in terms of time |
| maxClusterStabilityLevel | M | Integer | This indicates the maximum level of |
| | | | stability that can trigger the operation. |
| | | | allowedValues: { 0 . . . 100 } |
| outliersCount: | O | Integer | It indicates the number of outliers that |
| | | | have been generated from performing |
| | | | the operation. |

As shown in Table 3, the OperationId may correspond to an Id that points to a particular operation running under a particular cluster monitoring request. The Type attribute may correspond to a classify, expand, break, merge, and/or reset operation. The EventType may correspond to a type of defined event or output in analytics that can be the trigger for the operation in question. In some example embodiments, the EventType attribute may be optional. The MmnAccuracy may correspond to the minimum acceptable accuracy for an operation to be triggered and result in a change in the clusters. The ConditionFullfillmentCheckRate may indicate how often the operation conditions should be checked. It may be on a higher frequency for classification operation, and may expand operations compared to a reset operation. This attribute may either be defined in terms of time or in terms of a number of inferences. If it is not specified, a default value may be assigned to it. The MaxClusterStabilityLevel attribute may indicate the maximum level of stability that can trigger an operation. In some example embodiments, the stability of a cluster may be defined as a ratio of nodes that has never changed their cluster over the original size of the cluster. This attribute may also be one indicator of the drive in the data. Further, the OutliersCount attribute may indicate the number of outliers that have been generated from performing this operation. This attribute may be an indicator of improper setting of accuracy or operation conditions, or the assignment of improper or insufficient features for this operation or the clustering criteria. The OutliersCount may also indicate that not all the nodes requesting to be part of this cluster may benefit from this service, and it may be better to exclude them from this service to maintain their performance.

In certain example embodiments, upon placing a request for dynamic monitoring of the clusters, a cluster monitoring process may be instantiated/executed. The cluster monitoring process may provide reports for any changes in the clusters, and the over multi-cluster management information to provide visibility into the status of the models. The attributes are outlined in Table 4, and may be used to provide reports that are initialized based on triggering any of the operations and, thus, changes in the clusters. For example, the attributes may be used in any way as long as their definition is not violated.

TABLE 4
Cluster monitoring process attributes

| | | Information Type/ | |
|---|---|---|---|
| Parameter Name | S | Legal Values | Description |
| clusterMonitoringProcessId | M | String | It indicates an ID allocated for a |
| | | | particular |
| | | | ClusterDynMonitoringRequestId. |
| minOveralAccuracy | CM | ModelPerformance | The minimum observed accuracy value |
| | | | among all the clusters in the past |
| | | | ReportTimeWindow |
| | | | allowedValues: |
| averageAccuracy | CM | ModelPerformance | The average accuracy value over the |
| | | | clusters in the past ReportTimeWindow. |
| nodeOutlierPercentage | O | Integer | The percentage of nodes that have been |
| | | | ammounced as outliers to the clustering |
| | | | process and exited the process. This is |
| | | | reported not for a particular time |
| | | | window but based on the original |
| | | | number of nodes and the current |
| | | | participating nodes in the cluster |
| | | | allowedValues: { 0 . . . 100 } |
| ClusterReportRef | M | String | it refers to the ids of the cluster reports |
| | | | that provides detailed internal statistics |
| | | | for each cluster. |
| OperationsHistory | | | It refers to the last few operations that |
| | | | have been performed. |
| HistoryclusteringContext | M | ML Context | it describes the specific conditions for |
| | | | for which the clusters are created |

As shown in Table 4, ClusterDynMonitoringProcessId may correspond to the ID of the process allocated for a particular ClusterDynMonitoringRequestId. In certain example embodiments, a ClusterDynMonitoringRequest may be associated with only one monitoring process. The MinOveralAccuracy may correspond to the minimum observed accuracy value among all the clusters in the past ReportTimeWindow. The averageAccuracy attribute may correspond to the average accuracy value over the clusters in the past ReportTimeWindow. Further, the NodeOutlierPercentage attribute may correspond to the percentage of nodes that have been announced as outliers to the clustering process and exited the process. This may be reported not for a particular time window, but based on the original number of nodes and the current participating nodes in the cluster. The ClusterReportRef may refer to the IDs of the cluster reports that provide detailed internal statistics for each cluster. Additionally, the OperationsHistory attribute may refer to the last few operations that have been performed.

In certain example embodiments, a set of attributes that can reflect the status of the cluster and act as an indicator of the cluster's information may be provided. In some example embodiments, a cluster may have monitoring attributes (see Table 5) that signal the overall performance of the cluster and consequently trigger any of the operations described above to keep the performance of the clusters within expectation.

TABLE 5
Attributes in cluster reports

| | | Information Type/ | |
|---|---|---|---|
| Parameter Name | S | Legal Values | Description |
| clusterId | M | String | The id of the cluster pointing to an |
| | | | existing running cluster and |
| clusterAccuracy | M | ModelPerformance | It is the average accuracy of the |
| | | | nodes/instances over the last |
| | | | ReportTimeWindow. |
| minClusterAccuracy | O | ModelPerformance | It is the minimum accuracy level in the |
| | | | cluster over the last ReportTimeWindow. |
| clusterAcurracyQuartiles | Q | Real | The quartiles of the accuracy of the nodes |
| | | | in the cluster with the id of ClusterId |
| | | | over the last ReportTimeWindow. |
| clusterStabilitylevel | M | Integer | It is a percentage indicating the ratio of |
| | | | nodes that has never changed their cluster |
| | | | (in comparison to the original clustering) |
| | | | to the size of the original cluster. |
| | | | allowedValue: {0 . . . 100} |
| guestNodes | M | DN | It refers to the list of entities/nodes that |
| | | | has once been classified in the cluster and |
| | | | used its model |
| originalNodes | M | DN | It refers to the list of entities/nodes that |
| | | | were assigned to the cluster when the |
| | | | cluster was formed |
| neighborCluster | O | String | The id of the cluster(s) where most of the |
| | | | classification operations has landed in |
| | | | excluding itself in the last |
| | | | ReportTimeWindow. |

As shown in Table 5, the ClusterId may correspond to the ID of the cluster pointing to an existing running cluster and, thus, a unique combination of MLEntityId and version. The AvgClusterAccuracy may correspond to the average accuracy of the nodes/instances in the cluster with cluster ID of ClusterId over the last ReportTimeWindow. The MinClusterAccuracy may correspond to the accuracy of the node with the minimum accuracy level in the cluster with the ID of the ClusterId over the last ReportTimeWindow. The ClusterAccuracyQuartiles may represent quartiles of the accuracy of the nodes in their cluster withy the ID of ClusterId over the last ReportTimeWindow. The ClusterStabilitylevel may present the level of cluster stability in terms of percentage or ratio. It may be defined as the ratio of nodes that has never changed their cluster (in comparison to the original clustering) to the size of the original cluster. This value may be mandatory and may be reset when any of the operations except for classify is performed for a cluster. Thus, the stability level of a newly generated cluster (i.e., new version of the MLEntity) is always 1 or 100. In certain example embodiments, the classification may impact the value and result in modification, but does not reset the value. The value may not be modified if the version of MLEntity is not modified (thus, no training has been performed).

As further shown in Table 5, the GuestNodes refer to the list of node IDs that has once been classified in the cluster and used its model. These nodes may be seen as transient nodes. This list shows the history of the cluster visitors and user over the ReportTimeWindow. It can also be the whole operational life of the model. The OriginalNodes refer to the ides of the nodes that were assigned to the cluster when the cluster was formed. The combination of the information from GuestNodes, ClsuterStabilityLevel, ClusterAccuracyQuartiles, and this attribute allows for implementation of a wide range of algorithms and mechanisms for differentiating the operations and identifying the best fitting operations. Further, the NeighborCluster represents the ID of the cluster(s) where most of the classification operations have landed in excluding itself in the last ReportTimeWindow.

According to certain example embodiments, the ML training MnS producer and the ML clustering MnS producer may be two separated management entities. However, the ML clustering service may be part of the ML training service, and both may be part of the same management service.

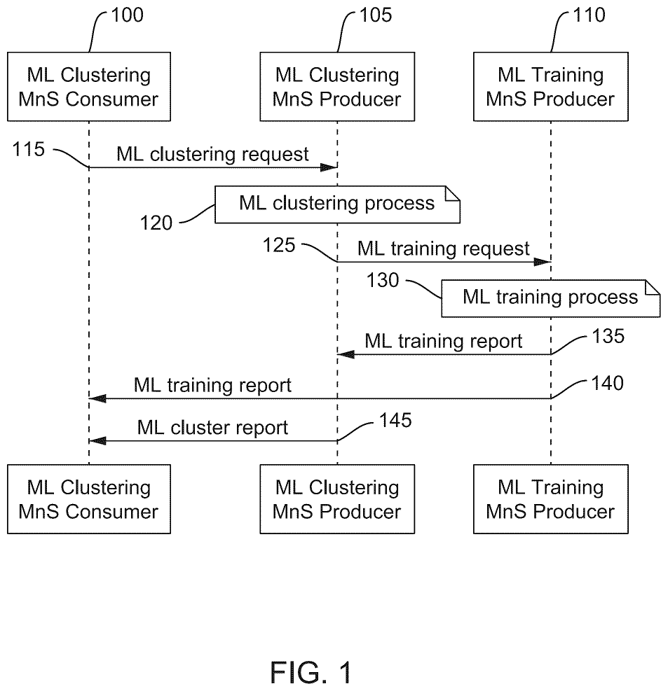

FIG. 1 illustrates an example signal diagram of a cluster creation request, according to certain example embodiments. As illustrated in FIG. 1, the signal diagram may involve an ML clustering MnS consumer 100, ML clustering MnS producer 105, and ML training MnS producer 110. The ML clustering MnS consumer 100 may be an authorized user of the service, and may include, for example, a network function, a management function, an operator, or another functional differentiation. The ML clustering MnS producer 105 may provide management services for the clustering, and the ML training MnS producer 110 may represent a function with ML training capabilities such as, for example, an ML training function that performs ML model training. At 115, the ML clustering MnS consumer 100 instantiates a request for creating a set of clusters associated with an MLEntity (MLEntity ID). In certain example embodiments, there may be various attributes needed for the cluster creation request to provide necessary information to perform a proper clustering (see above examples). At 120, the ML clustering MnS producer 205 creates multiple clusters of nodes based on the received request where one MLEntity may be separately trained on each cluster of nodes. At 125, after creating the clusters, the ML clustering MnS producer 105 instantiates one/multiple ML training requests for each cluster. At 130, the ML training MnS producer 110 runs the ML training process, and, at 135 and 140, compiles an ML training report and notifies the ML clustering MnS producer 105 and/or ML clustering MnS consumer 100 when the training is done (i.e., new versions of MLEntities available). At 145, the ML clustering MnS producer 105 compiles clustering report(s), a report per each cluster crated to summarize the different clusters' characteristics. The ML clustering MnS producer 110 also notifies the ML clustering MnS consumer 100 when the report is ready.

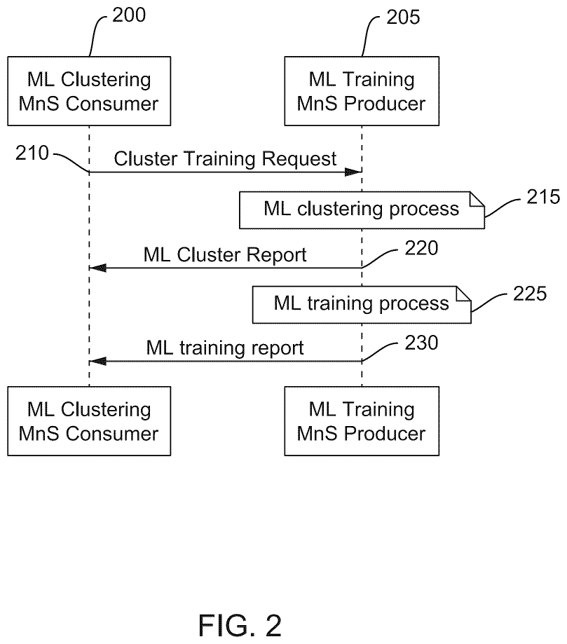

FIG. 2 illustrates an example signal diagram of another cluster creation request, according to certain example embodiments. In particular, FIG. 2 illustrates an alternative procedure for requesting a clusters creation by an authorized ML clustering MnS consumer (e.g., operator). In the example illustrated in FIG. 2, the services of the clustering MnS producer may be added to the ML training MnS producer (i.e., encapsulates the ML clustering responsibilities), and the training request may encapsulate the cluster report as well as the existing attributes. As illustrated in FIG. 2, at 210, the ML clustering MnS consumer 200 instantiates a request for creating a set of clusters associated with an MLEntity. At 215, the ML training MnS producer 205 creates multiple clusters of nodes where one MLEntity may be separately trained on each cluster of nodes. At 220, the ML training MnS producer 205 transmits a ML training report to the ML clustering MnS consumer 200, where the report may include, per each cluster created, a summary of the different cluster characteristics, and notify the ML clustering MnS consumer 200 when the report is ready. At 225, the ML training MnS producer 205 runs the ML training process, and, at 230, compiles an ML training report and notifies the ML clustering MnS consumer 200 when the training is done (new versions of MLEntities available).

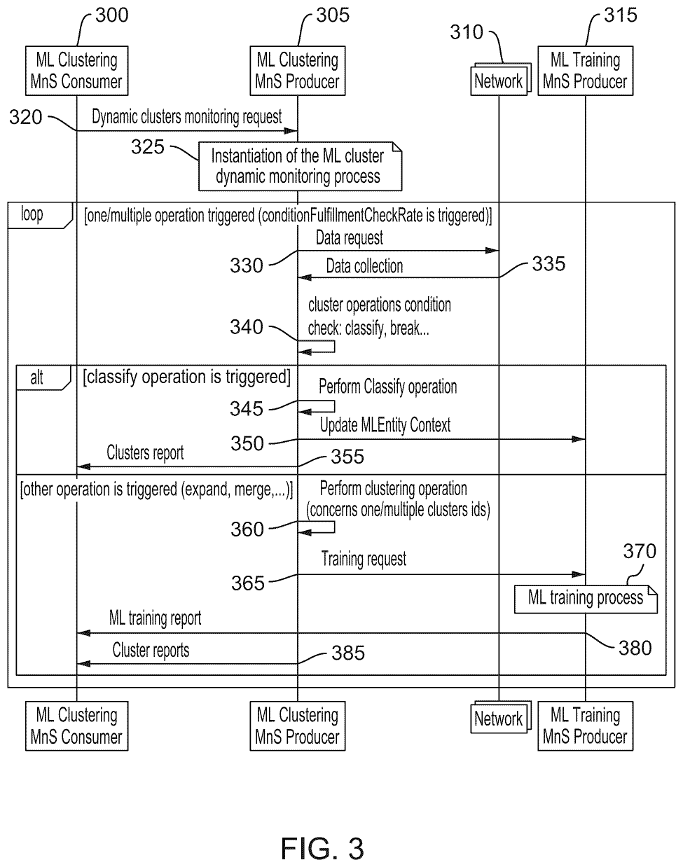

FIG. 3 illustrates an example signal diagram of a dynamic cluster monitoring request, according to certain example embodiments. At 320, the ML clustering MnS consumer 300 instantiates a request for cluster dynamic monitoring, wherein the request may be associated with a cluster creation request ID. At 325, the ML clustering MnS producer 305 instantiates a clusteringDynMonitoringProcess to dynamically monitor clusters based on some monitoring criteria and conditions as described above. At 330 and 335, the ML clustering MnS producer 305 controls the different operation triggers. When conditionFulfilmentCheckRate is triggered for one or multiple clusters, a data collection mechanism may be triggered to collect any needed data to evaluate the minAccuracy and maxClusterStability Level for the clusters of concern. At 340, the ML clustering MnS producer 305 checks if the one operation is triggered.

As illustrated in FIG. 3, if the classify operation is triggered, at 345, the nodes with ML models having an accuracy level lower than the minAccuracy are identified and reclassified to become associated to a different cluster (matching more accuracy requirements). At 350, the context of the MLEntities may be updated to take into consideration adding/removing nodes from one multiple clusters. At 355, the ML clustering MnS producer 305 transmits a clusters report to the ML clustering MnS consumer 300. The cluster reports may be generated to summarize the new clusters' state and ML clustering MnS consumer 300 is notified when the cluster reports are ready. As further illustrated in FIG. 3, when another operation is triggered (e.g., expand, break, breakNmerge, or reset), then at 360, the ML clustering MnS producer 305 performs the cluster operation selected based on operation triggering conditions (e.g., expand, break, breakNmerge, reset). Any of these operations may create/break/merge/remove one/multiple clusters. Thus, ML models training may be instantiated

At 365, based on the type of the operation triggered, the ML Clustering MnS producer 305 instantiates one/multiple training request(s) to train the ML model on the modified cluster(s). At 370, the ML training MnS producer 315 runs the training process. At 375, the ML training MnS producer 315 notifies the ML clustering MnS consumer 300 when the ML training process is complete, and the ML training report is ready and notified to the ML clustering MnS consumer 300. At 380, the ML clustering MnS consumer 300 is notified when the cluster reports are ready.

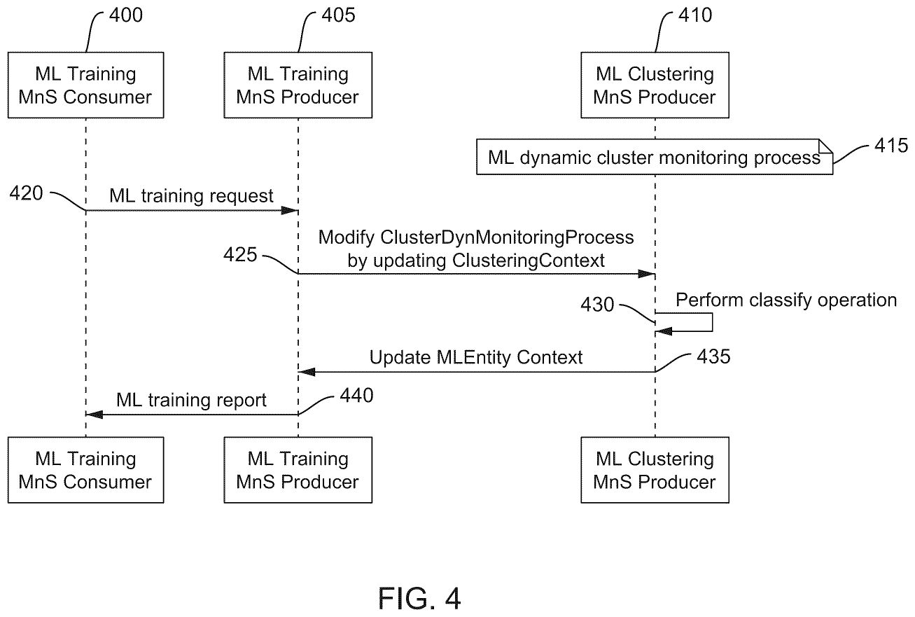

FIG. 4 illustrates an example signal diagram of a procedure for a machine learning training request, according to certain example embodiments. In particular, FIG. 4 illustrates a training request procedure similar to that of the training request 365 illustrated in FIG. 3. At 415, the ML clustering MnS producer 410 performs an ML dynamic cluster monitoring process. At 420, the ML training MnS consumer 400 instantiates a request for training an ML model. According to certain example embodiments, a clusters dynamic monitoring process may already be running, and the ML training request ML context may be part of the clustering ML context.

At 425, the ML training MnS producer 405 instantiates a change request for the clusteringContext part of the clusterDynMonitoringProcess. This attribute may be the list that all the nodes/DNs part of the one/multiple clusters monitored. At 430, the ML clustering MnS producer 410 performs a classification operation to define a cluster that the nodes concerned by the ML training request should be part of. At 435, the ML clustering MnS producer 410 updates the MLEntity of the cluster (runTimeContext attribute is updated). At 440, the ML training MnS producer 405 compiles a report and notifies the ML training MnS consumer 400 of the report.

In certain example embodiments, certain high level requirements may be defined. For example, in Req_1, the 3GPP management system may support the capability to perform cluster-based ML training of MLEntitites. In Req_2, the 3GPP management system may support the capability to create a set of clusters associated with an MLEntity (MLEntity ID) based on a selected set of similarities described by either a set of features or a group of different expectRuntimeContexts. Further, in Req_3, the 3GPP management system may support the capability to monitor the performance of a set of clusters associated with an MLEntity.

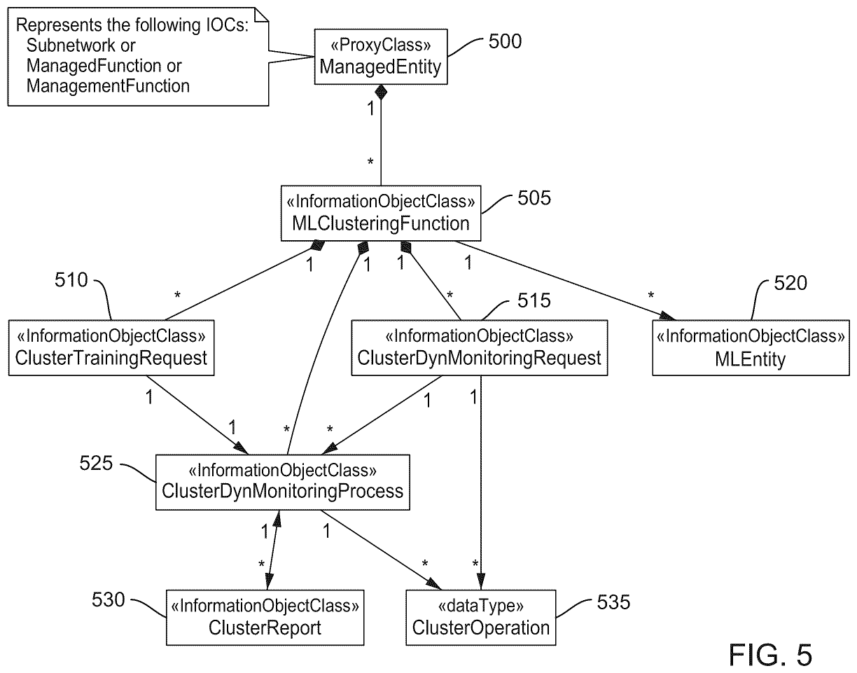

FIG. 5 illustrates a class unified modeling language diagram, according to certain example embodiments. In particular, FIG. 5 provides a visual presentation of the relationships between various entities defined herein. As illustrated in FIG. 5, the class unified modeling diagram may include a ProxyClass 500, InformationObjectClass 505, 510, 515, 520, 525, and 530 that respectively define a MLClusteringFunction, ClusterTrainingRequest, ClusterDynMonitoringRequest, MLEntity, ClusterDynMonitoringProcess, and ClusterReport. The class unified modeling diagram may also include a datatype 535, which defines a ClusterOperation.

As illustrated in FIG. 5, the ManagedEntity 500 may be associated with multiple MLClusteringFunctions 505. The MLClusteringFunction 505 may be responsible for performing all the clustering related tasks such as handling the requests for cluster training, monitoring of the clusters, and providing reports on the clusters and performance of the models.

In certain example embodiments, the MLClusteringFunction 505 may take care of multiple ClusterTrainingRequests 510. However, each ClusterTrainingRequest 510 may only be associated with one ClusterDynMonitoringProcess 525. The ClusterDynMonitoringProcess 525 may be the process that fulfills all the responsibilities of the maintenance and management of the clusters so that they may be within the defined framework conditions defined in its associated ClusterDynMonitoringRequest 515. The ClusterDynMonitoringRequests 515 (one or more than one) may also be associated with the MLClusteringFunction 505. In some example embodiments, the MLClusteringFunction 505 may manage all cluster related tasks for one or more of the MLEntities 520.

According to certain example embodiments, each ClusterDynMonitoringProcess 525 may produce several ClusterReports 530, and it may also have several ClusterOperation 535 objects that define the boundaries and conditions of action for each operation. According to some example embodiments, each ClusterDynMonitoringRequest 515 may be associated with one or more ClusterOperations 535 that reflect the desired conditions and operations that can be used to fulfill the request.

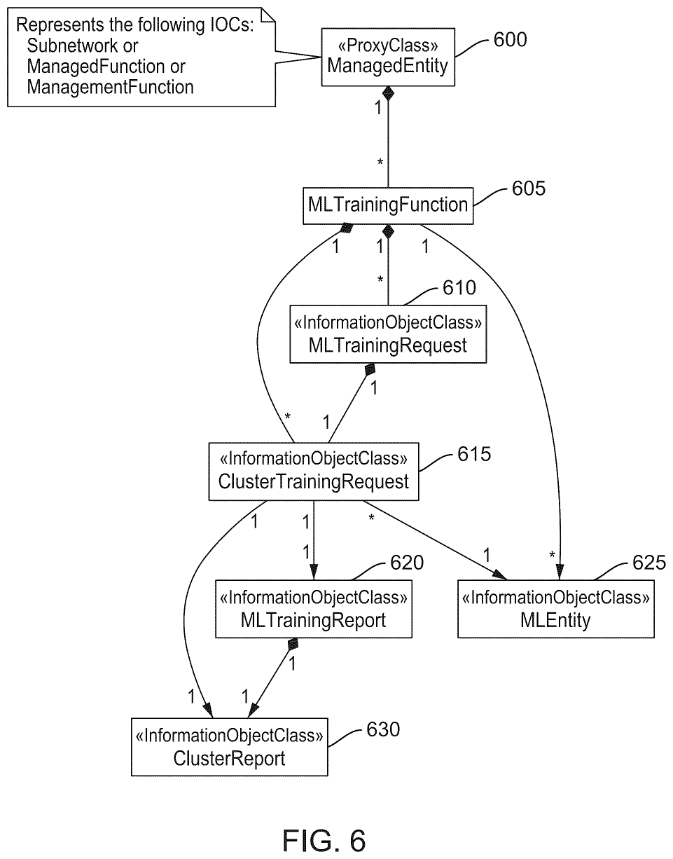

Additionally, FIG. 6 illustrates another class unified modeling language diagram, according to certain example embodiments. As illustrated in FIG. 6, the class unified modeling diagram may include a ProxyClass 600 defining a ManagedEntity, an MLTrainingFunction 605, an InformationObjectClass 610 defining an MLTrainingRequest, an InformationObjectClass 615 defining a ClusterTrainingRequest, an InformationObjectClass 620 defining an MLTrainingReport, an InformationObjectClass 625 defining an MLEntity, and an InformationObjectClass 630 defining a ClusterReport.

As illustrated in FIG. 6, the MLTrainingFunction 605 may be responsible for training the MLEntitites 625. According to certain example embodiments, the MLTrainingFunction 605 may be expanded to support an improved version of the MLTrainingRequest 610. Additionally, the new MLTrainingRequest 610 may encapsulate the markers for the ClusterTrainingRequest 615. Further, the ClusterTrainingRequest 615 may then produce MLTrainingReports 620 for the training as well as the clustering. Thus, the new MLTrainingReport may be associated with a ClusterReport 630. In some example embodiments, the responsibilities and features of the cluster related boxes may remain similar to that illustrated in FIG. 5. However, the MLTrainingRequest and MLTrainingReport may be expanded as described herein.

As illustrated in FIGS. 5 and 6, the information object class (IOC) MLClusteringFunction represents the entity that undertakes the clustering operation(creation, dynamic monitoring), and that is the container of the ClusterTrainingRequest and the ClusterDynMonitoringRequest IOC(s). The entity represented by MLClusteringFunction MOI supports clustering of ML models related to one or more MLEntity(ies).

TABLE 6
MLClusteringFunction attributes

| Attribute | Support | | | | |
|---|---|---|---|---|---|
| name | Qualifier | isReadable | isWritable | isInvariant | isNotifyable |
| mLEntityList | M | T | F | F | F |
| mlclusteringMethodList | M | T | F | F | F |

As illustrated in FIGS. 5 and 6 and shown in Table 7, the IOC may represent the properties of the ClusterTrainingRequest. For each request to cluster and train ML models, a consumer may instantiate a new ClusterTrainingRequest on the MLClusteringFunction. Each ClusterTrainingREgeust may be associated with one MLEntity (e.g., one MLEntityID and any one of multiple MLEntityVersions). The ClusterTrainingRequest may include an attribute, minClusterSize, to indicate the minimum numbers of nodes that can form a cluster. Additionally, the ClusterTrainingRequest may include an attribute, minExpectedAccuracy, to indicate the minimum allowed accuracy value for a cluster to be formed. The ClusterTrainingRequest may also include an attribute, maxNodeOutlierPercentage, to indicate a percentage of maximum nodes that are allowed to be outliers to the clustering process. The ClusterTrainingRequest may further include an attribute, clusteringMethodId, which indicates the ID of the clustering method to be used. In certain example embodiments, the expectedRuntimeContextSet may be a set of expectedRuntimeContexts for which the referenced MLEntity would be trained.

TABLE 7
ClusterTrainingRequest attributes

| | Support | | | | |
|---|---|---|---|---|---|
| Attribute name | Qualifier | isReadable | isWritable | isInvariant | isNotifyable |
| clusterTrainingRequestId | M | T | F | F | T |
| mlEntityId | M | T | F | F | T |
| clusteringCriteriaFeatures | O | T | T | F | T |
| clusteringCriteriaOnly | M | T | T | F | T |
| minClusterSize | O | T | T | F | T |
| minExpectedAccuracy | M | T | T | F | T |
| acceptedAccuracyMargin | O | T | T | F | T |
| maxNodeOutlierPercentage | O | T | T | F | T |
| clusteringMethodId | M | T | T | F | T |
| expectedRuntimeContextSet | O | | | | |

As illustrated in FIGS. 5 and 6 and shown in Table 8, the IOC ClusterDynMonitoringRequest may represent the request for dynamic monitoring of a set of clusters. The IOC ClusterDynMonitoringRequest may be instantiated by an authorized ML clustering MnS consumer, and may include clusteringOperationConditions and reportTimeWindow. The clusteringOperationConditions may indicate the operation characteristics that provide the information necessary for managing and controlling each operation. Additionally, the reportTimeWindow may indicate the time window that is considered for calculation of the statistical information in the reports and operations when no time frame is specified. Each ClusterTrainingRequest may be associated with one MLEntity (one mlEntityID, multiple mlEntityVersions). The ClusterTrainingRequest may also be associated with one/multiple clusterIds indicating the list of clusters to be handled by the monitoring request.

TABLE 8
ClusterDynMonitoringRequest attributes

| | Support | | | | |
|---|---|---|---|---|---|
| Attribute name | Qualifier | isReadable | isWritable | isInvariant | isNotifyable |
| clusterDynMonitoringRequestId | M | T | F | F | T |
| mlEntityId | M | T | F | F | T |
| mlEntityVersions | M | T | F | F | T |
| clusterIds | O | T | F | F | T |
| clusteringOperationConditons | M | T | T | F | T |
| reportTimeWindow | M | T | T | F | T |
| Attribute related to role | | | | | |
| mlEntityRef | M | T | F | T | F |
| clusterTrainingRequestRef | M | T | F | T | F |

As illustrated in FIGS. 5 and 6 and shown in Table 9, the IOC ClusterDynMonitoringProcess may represent the dynamic monitoring process of a set of clusters. In certain example embodiments, one ClusterDynMonitoringProcess managed object instance (MOI) may be instantiated for each ClusterDynMonitoringRequest. In other example embodiments, the ClusterDynMonitoringProcess may be associated with exactly one MLEntity but with different versions of this MLEntity.

TABLE 9
ClusterDynMonitoringProcess attributes

| | Support | | | | |
|---|---|---|---|---|---|
| Attribute name | Qualifier | isReadable | is Writable | isInvariant | isNotifyable |
| clusterMonitoringProcessId | M | T | F | F | T |
| minOveralAccuracy | M | T | T | F | T |
| averageAccuracy | M | T | T | F | T |
| nodeOutlierPercentage | O | T | T | F | T |
| clusterReportRefIds | M | T | F | F | T |
| operationsHistory | O | T | F | F | T |
| Attribute related to role | | | | | |
| mlEntityRef | M | T | F | T | F |
| clusterTrainingRequestRef | M | T | F | T | F |
| ClusterDynMonitoringRequestRef | M | T | F | T | F |

As illustrated in FIGS. 5 and 6 and shown in Table 10, the ClusterReport data type may capture the results of performing a clustering operation to one cluster. The ClusterReport may include multiple attributes that can reflect the status of the cluster and act as an indicator of the cluster's information. In some example embodiments, one ClusterReport may be generated, and each type of a clustering operation may be performed. In certain example embodiments, content of the ClusterReport may be part of the MLTrainingReport.

TABLE 10
ClusterReport attributes

| | Support | | | | |
|---|---|---|---|---|---|
| Attribute name | Qualifier | isReadable | isWritable | isInvariant | isNotifyable |
| ClusterId | M | T | F | F | T |
| ClusterAccuracy | M | T | F | F | T |
| MinClusterAccuracy | O | T | F | F | T |
| ClusterAcurracyQuartiles | O | T | F | F | T |
| ClusterStabilitylevel | M | T | F | F | T |
| GuestNodes | M | T | F | F | T |
| OriginalNodes | M | T | F | F | T |
| NeighborCluster | O | T | F | F | T |

As illustrated in FIGS. 5 and 6 and shown in Table 11, the ClusterOperation may represent the characteristics of a clustering operation.

TABLE 11
ClusterOperation attributes

| | Support | | | | |
|---|---|---|---|---|---|
| Attribute name | Qualifier | isReadable | isWritable | isInvariant | isNotifyable |
| OperationId | M | T | T | F | T |
| Type | M | T | T | F | T |
| EventHandel | O | T | T | F | T |
| MinAccuracy | M | T | T | F | T |
| ConditionFullfillmentCheckRate | M | T | T | F | T |
| MaxClusterStabilityLevel | M | T | T | F | T |
| OutliersCount | O | T | T | F | T |

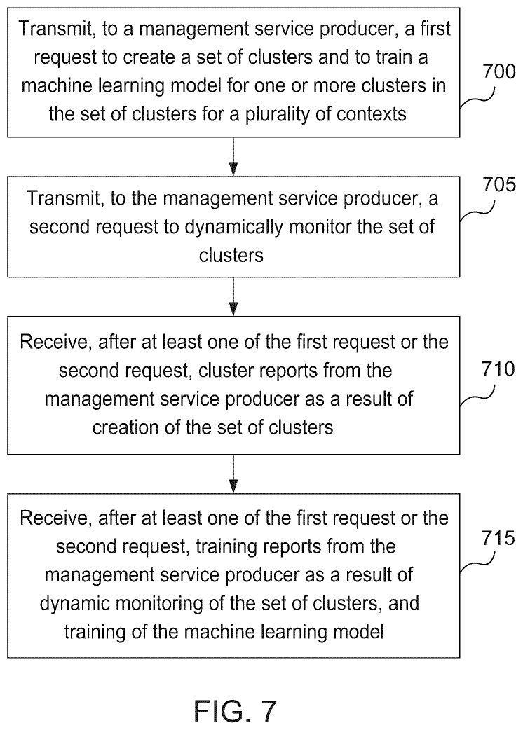

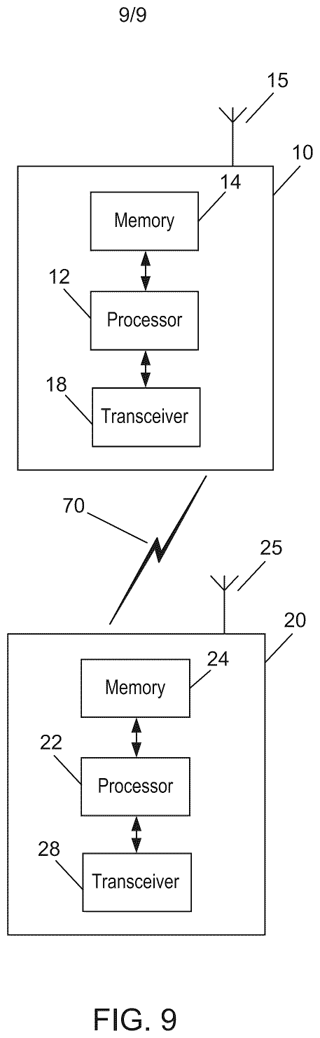

FIG. 7 illustrates an example flow diagram of a method, according to certain example embodiments. In an example embodiment, the method of FIG. 7 may be performed by a network entity, or a group of multiple network elements in a 3GPP system, such as LTE or 5G-NR. For instance, in an example embodiment, the method of FIG. 7 may be performed by an ML clustering MnS consumer similar to one of apparatuses 10 or 20 illustrated in FIG. 9.

According to certain example embodiments, the method of FIG. 7 may include, at 700, transmitting, to a management service producer, a first request to create a set of clusters and to train a machine learning model for one or more clusters in the set of clusters for a plurality of contexts. According to certain example embodiments, each cluster comprises a plurality of network nodes, network functions, and management functions. The method may also include, at 705, transmitting, to the management service producer, a second request to dynamically monitor the set of clusters. The method may further include, at 710, receiving, after at least one of the first request or the second request, cluster reports from the management service producer as a result of creation of the set of clusters. In addition, the method may include, at 715, receiving, after at least one of the first request or the second request, training reports from the management service producer as a result of dynamic monitoring of the set of clusters, and training of the machine learning model.

According to certain example embodiments, the cluster reports may include a report for each cluster, and the report for each cluster may include characteristics of the respective cluster, and a state of the respective cluster. According to some example embodiments, each network node, network function, and management function of the plurality of network nodes, network functions, and management functions may be associated with the same machine learning model. According to other example embodiments, the machine learning model may be identified by a machine learning entity identifier, the machine learning entity identifier associated with an input, an output, and architecture. According to further example embodiments, the first request and the second request may include a plurality of attributes for cluster creation and cluster dynamic monitoring, respectively.

In certain example embodiments, the plurality of attributes for cluster creation within the first request may include at least one of a machine learning model identifier, a clustering criteria feature, a Boolean attribute indicating whether clustering should only be performed based on the clustering criteria feature, a minimum cluster size requirement, a minimum allowed accuracy value for the clusters, an accepted accuracy margin, a maximum network node outlier percentage, an identification of a clustering method, or an expected run time context set. In some example embodiments, the plurality of attributes for cluster dynamic monitoring within the second request may include at least one of an identification of the request for dynamic monitoring, an identifier of the machine learning model, a list of versions of the machine learning model, a list of cluster identifiers that the dynamic monitoring request is handling, a list of operation objects that provide information for managing and controlling management operations, or a time window for calculation of statistical information in the reports.

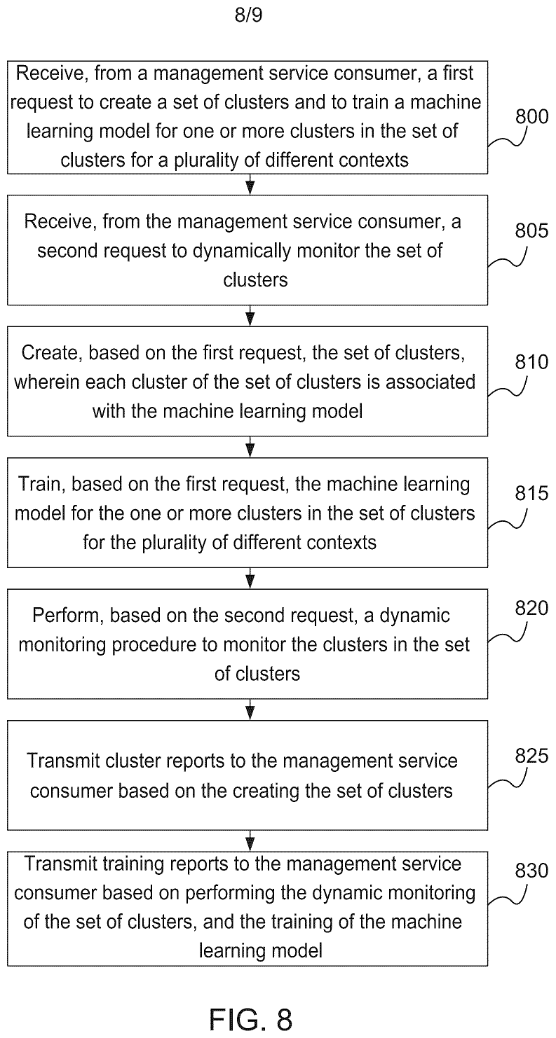

FIG. 8 illustrates an example flow diagram of a method, according to certain example embodiments. In an example embodiment, the method of FIG. 8 may be performed by a network entity, or a group of multiple network elements in a 3GPP system, such as LTE or 5G-NR. For instance, in an example embodiment, the method of FIG. 8 may be performed by an ML clustering MnS producer similar to one of apparatuses 10 or 20 illustrated in FIG. 9.

According to certain example embodiments, the method of FIG. 8 may include, at 800, receiving, from a management service consumer, a first request to create a set of clusters and to train a machine learning model for one or more clusters in the set of clusters for a plurality of different contexts. According to certain example embodiments, each cluster may include a plurality of network nodes, network functions, and management functions. The method may also include, at 805, receiving, from the management service consumer, a second request to dynamically monitor the set of clusters. The method may further include, at 810, creating, based on the first request, the set of clusters. According to certain example embodiments, each cluster of the set of clusters may be associated with the machine learning model. In addition, the method may include, at 815, training, based on the first request, the machine learning model for the one or more clusters in the set of clusters for the plurality of different contexts. Further, the method may include, at 820, performing, based on the second request, a dynamic monitoring procedure to monitor the clusters in the set of clusters. The method may also include, at 825, transmitting cluster reports to the management service consumer based on the creating the set of clusters. The method may further include, at 830, transmitting training reports to the management service consumer based on performing the dynamic monitoring of the set of clusters, and the training of the machine learning model.

According to certain example embodiments, the dynamic monitoring procedure may be performed dependent upon existence of a trigger, and the trigger may include fulfillment of a set of conditions specified in an operation for managing the one or more clusters including elements defined for management operation attributes. According to some example embodiments, the operation for managing the one or more clusters may include at least one of a classification operation of a network node which has the machine learning model, an expand operation of a cluster, a break operation of the cluster, a break and merge operation of the cluster, or a reset operation of the cluster. According to other example embodiments, each of the operation for managing the one or more clusters may include one or more attributes enabling management of the set of clusters.

In certain example embodiments, the cluster reports may include a report for each cluster summarizing different characteristics of each cluster, a state of each cluster, and an indication the report is ready. In some example embodiments, each network node, network function, and management function of the plurality of network nodes, network functions, and management functions may be associated with the same machine learning model. In other example embodiments, the machine learning model may be identified by a machine learning entity identifier, the machine learning identifier associated with an input, an output, and an architecture.

According to certain example embodiments, the first request and the second request may include a plurality of attributes for cluster creation and cluster dynamic monitoring, respectively. According to some example embodiments, the plurality of attributes for cluster creation within the first request may include at least one of a machine learning model identifier, a clustering criteria feature, a Boolean attribute indicating whether clustering should only be performed based on the clustering criteria feature, a minimum cluster size requirement, a minimum allowed accuracy value for the clusters, an accepted accuracy margin, a maximum network node outlier percentage, an identification of a clustering method, or an expected run time context set. According to the plurality of attributes for cluster dynamic monitoring within the second request may include at least one of an identification of the request for dynamic monitoring, an identifier of the machine learning model, a list of versions of the machine learning model, a list of cluster identifiers that the dynamic monitoring request is handling, a list of operation objects that provide information for managing and controlling management operations, or a time window for calculation of statistical information in the reports.

FIG. 9 illustrates a set of apparatuses 10 and 20 according to certain example embodiments. In certain example embodiments, apparatuses 10 and 20 may be elements in a communications network or associated with such a network. For example, apparatus 10 may be an ML clustering MnS consumer or other similar radio communication computer device, and apparatus 20 may be an ML clustering MnS producer.

In some example embodiments, apparatuses 10 and 20 may include one or more processors, one or more computer-readable storage medium (for example, memory, storage, or the like), one or more radio access components (for example, a modem, a transceiver, or the like), and/or a user interface. In some example embodiments, apparatuses 10 and 20 may be configured to operate using one or more radio access technologies, such as GSM, LTE, LTE-A, NR, 5G, WLAN, WiFi, NB-IoT, Bluetooth, NFC, MulteFire, and/or any other radio access technologies. It should be noted that one of ordinary skill in the art would understand that apparatuses 10 and 20 may include components or features not shown in FIG. 9.

As illustrated in the example of FIG. 9, apparatuses 10 and 20 may include or be coupled to a processors 12 and 22 for processing information and executing instructions or operations. Processors 12 and 22 may be any type of general or specific purpose processor. In fact, processors 12 and 22 may include one or more of general-purpose computers, special purpose computers, microprocessors, DSPs, field-programmable gate arrays (FPGAs), application-specific integrated circuits (ASICs), and processors based on a multi-core processor architecture, as examples. While a single processors 12 and 22 is shown in FIG. 9, multiple processors may be utilized according to other example embodiments. For example, it should be understood that, in certain example embodiments, apparatuses 10 and 20 may include two or more processors that may form a multiprocessor system (e.g., in this case processors 12 may represent a multiprocessor) that may support multiprocessing. According to certain example embodiments, the multiprocessor system may be tightly coupled or loosely coupled (e.g., to form a computer cluster).

Processors 12 and 22 may perform functions associated with the operation of apparatuses 10 and 20 including, as some examples, precoding of antenna gain/phase parameters, encoding and decoding of individual bits forming a communication message, formatting of information, and overall control of the apparatuses 10 and 20, including processes and examples illustrated in FIGS. 1-8.

Apparatuses 10 and 20 may further include or be coupled to a memories 14 and 24 (internal or external), which may be respectively coupled to processors 12 and 24 for storing information and instructions that may be executed by processors 12 and 24. Memories 14 and 24 may be one or more memories and of any type suitable to the local application environment, and may be implemented using any suitable volatile or nonvolatile data storage technology such as a semiconductor-based memory device, a magnetic memory device and system, an optical memory device and system, fixed memory, and/or removable memory. For example, memories 14 and 24 can be comprised of any combination of random access memory (RAM), read only memory (ROM), static storage such as a magnetic or optical disk, hard disk drive (HDD), or any other type of non-transitory machine or computer readable media. The instructions stored in memories 14 and 24 may include program instructions or computer program code that, when executed by processors 12 and 22, enable the apparatuses 10 and 20 to perform tasks as described herein.

In certain example embodiments, apparatuses 10 and 20 may further include or be coupled to (internal or external) a drive or port that is configured to accept and read an external computer readable storage medium, such as an optical disc, USB drive, flash drive, or any other storage medium. For example, the external computer readable storage medium may store a computer program or software for execution by processors 12 and 22 and/or apparatuses 10 and 20 to perform any of the methods and examples illustrated in FIGS. 1-8.

In some example embodiments, apparatuses 10 and 20 may also include or be coupled to one or more antennas 15 and 25 for receiving a downlink signal and for transmitting via an UL from apparatuses 10 and 20. Apparatuses 10 and 20 may further include a transceivers 18 and 28 configured to transmit and receive information. The transceivers 18 and 28 may also include a radio interface (e.g., a modem) coupled to the antennas 15 and 25. The radio interface may correspond to a plurality of radio access technologies including one or more of GSM, LTE, LTE-A, 5G, NR, WLAN, NB-IoT, Bluetooth, BT-LE, NFC, RFID, UWB, and the like. The radio interface may include other components, such as filters, converters (for example, digital-to-analog converters and the like), symbol demappers, signal shaping components, an Inverse Fast Fourier Transform (IFFT) module, and the like, to process symbols, such as OFDMA symbols, carried by a downlink or an UL.

For instance, transceivers 18 and 28 may be configured to modulate information on to a carrier waveform for transmission by the antennas 15 and 25 and demodulate information received via the antenna 15 and 25 for further processing by other elements of apparatuses 10 and 20. In other example embodiments, transceivers 18 and 28 may be capable of transmitting and receiving signals or data directly. Additionally or alternatively, in some example embodiments, apparatus 10 may include an input and/or output device (I/O device). In certain example embodiments, apparatuses 10 and 20 may further include a user interface, such as a graphical user interface or touchscreen.

In certain example embodiments, memories 14 and 34 store software modules that provide functionality when executed by processors 12 and 22. The modules may include, for example, an operating system that provides operating system functionality for apparatuses 10 and 20. The memory may also store one or more functional modules, such as an application or program, to provide additional functionality for apparatuses 10 and 20. The components of apparatuses 10 and 20 may be implemented in hardware, or as any suitable combination of hardware and software. According to certain example embodiments, apparatuses 10 and 20 may optionally be configured to communicate each other (in any combination) via a wireless or wired communication links 70 according to any radio access technology, such as NR.

According to certain example embodiments, processors 12 and 22 and memories 14 and 24 may be included in or may form a part of processing circuitry or control circuitry. In addition, in some example embodiments, transceivers 18 and 28 may be included in or may form a part of transceiving circuitry.

For instance, in certain example embodiments, apparatus 10 may be controlled by memory 14 and processor 12 to transmit, to a management service producer, a first request to create a set of clusters and to train a machine learning model for one or more clusters in the set of clusters for a plurality of contexts. According to certain example embodiments, each cluster may include a plurality of network nodes, network functions, and management functions. Apparatus 10 may also be controlled by memory 14 and processor 12 to transmit, to the management service producer, a second request to dynamically monitor the set of clusters. Apparatus 10 may further be controlled by memory 14 and processor 12 to receive, after at least one of the first request or the second request, cluster reports from the management service producer as a result of creation of the set of clusters. In addition, apparatus 10 may be controlled by memory 14 and processor 12 to receive, after at least one of the first request or the second request, training reports from the management service producer as a result of dynamic monitoring of the set of clusters, and training of the machine learning model.

In other example embodiments, apparatus 20 may be controlled by memory 24 and processor 22 to receive, from a management service consumer, a first request to create a set of clusters and to train a machine learning model for one or more clusters in the set of clusters for a plurality of different contexts. According to certain example embodiments, each cluster may include a plurality of network nodes, network functions, and management functions. Apparatus 20 may also be controlled by memory 24 and processor 22 to receive, from the management service consumer, a second request to dynamically monitor the set of clusters. Apparatus 20 may further be controlled by memory 24 and processor 22 to create, based on the first request, the set of clusters. According to certain example embodiments, each cluster of the set of clusters may be associated with the machine learning model. In addition, apparatus 20 may be controlled by memory 24 and processor 22 to train, based on the first request, the machine learning model for the one or more clusters in the set of clusters for the plurality of different contexts. Further, apparatus 20 may be controlled by memory 24 and processor 22 to perform, based on the second request, a dynamic monitoring procedure to monitor the clusters in the set of clusters. Apparatus 20 may also be controlled by memory 24 and processor 22 to transmit cluster reports to the management service consumer based on the creating the set of clusters. Apparatus 20 may further be controlled by memory 24 and processor 22 to transmit training reports to the management service consumer based on performing the dynamic monitoring of the set of clusters, and the training of the machine learning model.

In some example embodiments, an apparatus (e.g., apparatus 10 and/or apparatus 20) may include means for performing a method, a process, or any of the variants discussed herein. Examples of the means may include one or more processors, memory, controllers, transmitters, receivers, and/or computer program code for causing the performance of the operations.

Certain example embodiments may be directed to an apparatus that includes means for performing any of the methods described herein including, for example, means for transmitting, to a management service producer, a first request to create a set of clusters and to train a machine learning model for one or more clusters in the set of clusters for a plurality of contexts. According to certain example embodiments, each cluster may include a plurality of network nodes, network functions, and management functions. The apparatus may also include means for transmitting, to the management service producer, a second request to dynamically monitor the set of clusters. The apparatus may further include means for receiving, after at least one of the first request or the second request, cluster reports from the management service producer as a result of creation of the set of clusters. In addition, the apparatus may include means for receiving, after at least one of the first request or the second request, training reports from the management service producer as a result of dynamic monitoring of the set of clusters, and training of the machine learning model.

Other example embodiments may be directed to an apparatus that includes means for performing any of the methods described herein including, for example, means for receiving, from a management service consumer, a first request to create a set of clusters and to train a machine learning model for one or more clusters in the set of clusters for a plurality of different contexts. According to certain example embodiments, each cluster may include a plurality of network nodes, network functions, and management functions. The apparatus may also include means for receive, from the management service consumer, a second request to dynamically monitor the set of clusters. The apparatus may further include means for creating, based on the first request, the set of clusters. According to certain example embodiments, each cluster of the set of clusters may be associated with the machine learning model. In addition, the apparatus may include means for training, based on the first request, the machine learning model for the one or more clusters in the set of clusters for the plurality of different contexts. Further, the apparatus may include means for performing, based on the second request, a dynamic monitoring procedure to monitor the clusters in the set of clusters. The apparatus may also include means for transmitting cluster reports to the management service consumer based on the creating the set of clusters. The apparatus may further include means for transmitting training reports to the management service consumer based on performing the dynamic monitoring of the set of clusters, and the training of the machine learning model.

Certain example embodiments described herein provide several technical improvements, enhancements, and/or advantages. For instance, in some example embodiments, it may be possible to enable the management system to optimize computational resources by performing training of ML entities once for an entire cluster. In other example embodiments, it may be possible to enable an authorized consumer to monitor the available clusters and adjust them according to a preferred criteria. In further example embodiments, it may be possible to reduce the complexity in the maintenance of the models, and provide the ability to gain further knowledge and insight on network performance changes and the environment's impact on the network entities in a statistical and tangible manner.

A computer program product may include one or more computer-executable components which, when the program is run, are configured to carry out some example embodiments. The one or more computer-executable components may be at least one software code or portions of it. Modifications and configurations required for implementing functionality of certain example embodiments may be performed as routine(s), which may be implemented as added or updated software routine(s). Software routine(s) may be downloaded into the apparatus.

As an example, software or a computer program code or portions of it may be in a source code form, object code form, or in some intermediate form, and it may be stored in some sort of carrier, distribution medium, or computer readable medium, which may be any entity or device capable of carrying the program. Such carriers may include a record medium, computer memory, read-only memory, photoelectrical and/or electrical carrier signal, telecommunications signal, and software distribution package, for example. Depending on the processing power needed, the computer program may be executed in a single electronic digital computer or it may be distributed amongst a number of computers. The computer readable medium or computer readable storage medium may be a non-transitory medium.

In other example embodiments, the functionality may be performed by hardware or circuitry included in an apparatus (e.g., apparatus 10 or apparatus 20), for example through the use of an application specific integrated circuit (ASIC), a programmable gate array (PGA), a field programmable gate array (FPGA), or any other combination of hardware and software. In yet another example embodiment, the functionality may be implemented as a signal, a non-tangible means that can be carried by an electromagnetic signal downloaded from the Internet or other network.

According to certain example embodiments, an apparatus, such as a node, device, or a corresponding component, may be configured as circuitry, a computer or a microprocessor, such as single-chip computer element, or as a chipset, including at least a memory for providing storage capacity used for arithmetic operation and an operation processor for executing the arithmetic operation.

One having ordinary skill in the art will readily understand that the disclosure as discussed above may be practiced with procedures in a different order, and/or with hardware elements in configurations which are different than those which are disclosed. Therefore, although the disclosure has been described based upon these example embodiments, it would be apparent to those of skill in the art that certain modifications, variations, and alternative constructions would be apparent, while remaining within the spirit and scope of example embodiments. Although the above embodiments refer to 5G NR and LTE technology, the above embodiments may also apply to any other present or future 3GPP technology, such as LTE-advanced, and/or fourth generation (4G) technology.

### Partial Glossary

3GPP 3rd Generation Partnership Project
5G 5th Generation
5GCN 5G Core Network
5GS 5G System
AI Artificial Intelligence
BS Base Station
DL Downlink
eNB Enhanced Node B
E-UTRAN Evolved UTRAN
gNB 5G or Next Generation NodeB
LTE Long Term Evolution
ML Machine Learning
NR New Radio
PRACH Physical Random Access Channel
RACH Random Access Channel
UE User Equipment
UL Uplink

We claim:

1. A method, comprising:
receiving, from a management service consumer, a first request to create a set of clusters and to train a machine learning model for one or more clusters in the set of clusters for a plurality of different contexts, wherein each cluster comprises a plurality of network nodes, network functions, and management functions;
receiving, from the management service consumer, a second request to dynamically monitor the set of clusters;
creating, based on the first request, the set of clusters, wherein each cluster of the set of clusters is associated with the machine learning model;
training, based on the first request, the machine learning model for the one or more clusters in the set of clusters for the plurality of different contexts;
performing, based on the second request, a dynamic monitoring procedure to monitor the clusters in the set of clusters;
transmitting cluster reports to the management service consumer based on the creating the set of clusters; and
transmitting training reports to the management service consumer based on performing the dynamic monitoring of the set of clusters, and the training of the machine learning model.

2. The method according to claim 1,
wherein the dynamic monitoring procedure is performed dependent upon existence of a trigger, and
wherein the trigger comprises fulfillment of a set of conditions specified in an operation for managing the one or more clusters including elements defined for management operation attributes.

3. The method according to claim 2, wherein the operation for managing the one or more clusters comprises at least one of the following:
a classification operation of a network node which has the machine learning model,
an expand operation of a cluster,
a break operation of the cluster,
a break and merge operation of the cluster, or
a reset operation of the cluster.

4. The method according to claim 2, wherein each of the operation for managing the one or more clusters comprises one or more attributes enabling management of the set of clusters.

5. The method according to claim 1, wherein the cluster reports comprise a report for each cluster summarizing different characteristics of each cluster, a state of each cluster, and an indication the report is ready.

6. The method according to claim 1,
wherein each network node, network function, and management function of the plurality of network nodes, network functions, and management functions is associated with the same machine learning model, and
wherein the machine learning model is identified by a machine learning entity identifier, the machine learning identifier associated with an input, an output, and an architecture.

7. The method according to claim 1, wherein the first request and the second request comprises a plurality of attributes for cluster creation and cluster dynamic monitoring, respectively.

8. The method according to claim 7, wherein the plurality of attributes for cluster creation within the first request comprises at least one of the following:
a machine learning model identifier,
a clustering criteria feature,
a Boolean attribute indicating whether clustering should only be performed based on the clustering criteria feature,
a minimum cluster size requirement,
a minimum allowed accuracy value for the clusters,
an accepted accuracy margin,
a maximum network node outlier percentage,
an identification of a clustering method, or
an expected run time context set.

9. The method according to claim 7, wherein the plurality of attributes for cluster dynamic monitoring within the second request comprises at least one of the following:
an identification of the request for dynamic monitoring,
an identifier of the machine learning model,
a list of versions of the machine learning model,
a list of cluster identifiers that the dynamic monitoring request is handling,
a list of operation objects that provide information for managing and controlling management operations, or
a time window for calculation of statistical information in the reports.

10. An apparatus, comprising:
at least one processor; and
at least one memory comprising computer program code which, when executed by the at least one processor, cause the apparatus at least to
receive, from a management service consumer, a first request to create a set of clusters and to train a machine learning model for one or more clusters in the set of clusters for a plurality of different contexts, wherein each cluster comprises a plurality of network nodes, network functions, and management functions;
receive, from the management service consumer, a second request to dynamically monitor the set of clusters;
create, based on the first request, the set of clusters, wherein each cluster of the set of clusters is associated with the machine learning model;
train, based on the first request, the machine learning model for the one or more clusters in the set of clusters for the plurality of different contexts;
perform, based on the second request, a dynamic monitoring procedure to monitor the clusters in the set of clusters;
transmit cluster reports to the management service consumer based on the creating the set of clusters; and
transmit training reports to the management service consumer based on performing the dynamic monitoring of the set of clusters, and the training of the machine learning model.

11. The apparatus according to claim 10,
wherein the dynamic monitoring procedure is performed dependent upon existence of a trigger, and
wherein the trigger comprises fulfillment of a set of conditions specified in an operation for managing the one or more clusters including elements defined for management operation attributes.

12. The apparatus according to claim 11, wherein the operation for managing the one or more clusters comprises at least one of the following:
a classification operation of a network node which has the machine learning model,
an expand operation of a cluster,
a break operation of the cluster,
a break and merge operation of the cluster, or
a reset operation of the cluster.

13. The apparatus according to claim 11, wherein each of the operation for managing the one or more clusters comprises one or more attributes enabling management of the set of clusters.

14. The apparatus according to claim 10, wherein the cluster reports comprise a report for each cluster summarizing different characteristics of each cluster, a state of each cluster, and an indication the report is ready.

15. The apparatus according to any of claim 10,
wherein each network node, network function, and management function of the plurality of network nodes, network functions, and management functions is associated with the same machine learning model, and
wherein the machine learning model is identified by a machine learning entity identifier, the machine learning identifier associated with an input, an output, and an architecture.

16. The apparatus according to claim 10, wherein the first request and the second request comprises a plurality of attributes for cluster creation and cluster dynamic monitoring, respectively.

17. The apparatus according to claim 16, wherein the plurality of attributes for cluster creation within the first request comprises at least one of the following:
a machine learning model identifier,
a clustering criteria feature,
a Boolean attribute indicating whether clustering should only be performed based on the clustering criteria feature,
a minimum cluster size requirement,
a minimum allowed accuracy value for the clusters,
an accepted accuracy margin,
a maximum network node outlier percentage,
an identification of a clustering method, or
an expected run time context set.

18. The apparatus according to claim 16 wherein the plurality of attributes for cluster dynamic monitoring within the second request comprises at least one of the following:
an identification of the request for dynamic monitoring,
an identifier of the machine learning model,
a list of versions of the machine learning model,
a list of cluster identifiers that the dynamic monitoring request is handling,
a list of operation objects that provide information for managing and controlling management operations, or
a time window for calculation of statistical information in the reports.

19. A non-transitory computer readable medium comprising program instructions which, when executed by an apparatus, cause the apparatus at least to:
receive, from a management service consumer, a first request to create a set of clusters and to train a machine learning model for one or more clusters in the set of clusters for a plurality of different contexts, wherein each cluster comprises a plurality of network nodes, network functions, and management functions;
receive, from the management service consumer, a second request to dynamically monitor the set of clusters;
create, based on the first request, the set of clusters, wherein each cluster of the set of clusters is associated with the machine learning model;
train, based on the first request, the machine learning model for the one or more clusters in the set of clusters for the plurality of different contexts;
perform, based on the second request, a dynamic monitoring procedure to monitor the clusters in the set of clusters;
transmit cluster reports to the management service consumer based on the creating the set of clusters; and
transmit training reports to the management service consumer based on performing the dynamic monitoring of the set of clusters, and the training of the machine learning model.

20. The non-transitory computer readable medium according to claim 19,
wherein the dynamic monitoring procedure is performed dependent upon existence of a trigger, and
wherein the trigger comprises fulfillment of a set of conditions specified in an operation for managing the one or more clusters including elements defined for management operation attributes.
